(19) United States
(12) Patent Application Publication
(10) Pub. No.: US 2017/0109751 A1
(43) Pub. Date: Apr. 20, 2017

(54) SYSTEM AND METHOD FOR CARRYING STRONG AUTHENTICATION EVENTS OVER DIFFERENT CHANNELS

(71) Applicant: NOK NOK LABS, INC., Palo Alto, CA (US)

(72) Inventors: Phillip Dunkelberger, Saratoga, CA (US); Rolf Lindemann, Steele (DE)

(21) Appl. No.: 14/268,563

(22) Filed: May 2, 2014

(51) Int. Cl. G06Q 20/40

(52) U.S. Cl. CPC G06Q 20/4014

(57) ABSTRACT

A system, apparatus, method, and machine readable medium are described for performing authentication over multiple channels. For example, one embodiment of a method comprises: performing authentication over a network with an authentication service to authenticate a client; responsively generating a token at the authentication service, the token including identification information for the client, a service, and a type of authenticator used for the authentication, the token further including verification data; transmitting the token to the client; transmitting the token from the client to the service, the service using the verification data to verify the token and allowing one or more transactions with the client in accordance with a policy based, at least in part, on the type of authenticator used for the authentication.

### BACKGROUND

Field of the Invention

This invention relates generally to the field of data processing systems. More particularly, the invention relates to a system and method for carrying strong authentication events over different channels.

Description of Related Art

Systems have also been designed for providing secure user authentication over a network using biometric sensors. In such systems, the a score generated by an authenticator, and/or other authentication data, may be sent over a network to authenticate the user with a remote server. For example, Patent Application No. 2011/0082801 (“'801 Application”) describes a framework for user registration and authentication on a network which provides strong authentication (e.g., protection against identity theft and phishing), secure transactions (e.g., protection against “malware in the browser” and “man in the middle” attacks for transactions), and enrollment/management of client authentication tokens (e.g., fingerprint readers, facial recognition devices, smartcards, trusted platform modules, etc).

The assignee of the present application has developed a variety of improvements to the authentication framework described in the '801 application. Some of these improvements are described in the following set of US Patent Applications (“Co-pending Applications”), which are assigned to the present assignee: Ser. No. 13/730,761, Query System and Method to Determine Authentication Capabilities; Ser. No. 13/730,776, System and Method for Efficiently Enrolling, Registering, and Authenticating With Multiple Authentication Devices; Ser. No. 13/730,780, System and Method for Processing Random Challenges Within an Authentication Framework; Ser. No. 13/730,791, System and Method for Implementing Privacy Classes Within an Authentication Framework; Serial No. 13/730,795, System and Method for Implementing Transaction Signaling Within an Authentication Framework; and Ser. No. 14/218,504, Advanced Authentication Techniques and Applications (hereinafter “'504 Application”).

Briefly, the Co-Pending Applications describe authentication techniques in which a user enrolls with authentication devices (or Authenticators) such as biometric devices (e.g., fingerprint sensors) on a client device. When a user enrolls with a biometric device, biometric reference data is captured (e.g., by swiping a finger, snapping a picture, recording a voice, etc). The user may subsequently register the authentication devices with one or more servers over a network (e.g., Websites or other relying parties equipped with secure transaction services as described in the Co-Pending Applications); and subsequently authenticate with those servers using data exchanged during the registration process (e.g., cryptographic keys provisioned into the authentication devices). Once authenticated, the user is permitted to perform one or more online transactions with a Website or other relying party. In the framework described in the Co-Pending Applications, sensitive information such as fingerprint data and other data which can be used to uniquely identify the user, may be retained locally on the user's authentication device to protect a user's privacy. The '504 Application describes a variety of additional techniques including techniques for designing composite authenticators, intelligently generating authentication assurance levels, using non-intrusive user verification, transferring authentication data to new authentication devices, augmenting authentication data with client risk data, and adaptively applying authentication policies, and creating trust circles, to name just a few.

### BRIEF DESCRIPTION OF THE DRAWINGS

A better understanding of the present invention can be obtained from the following detailed description in conjunction with the following drawings, in which:

FIGS. 1A-B illustrate two different embodiments of a secure authentication system architecture;

FIG. 2 is a transaction diagram showing how keys may be registered into authentication devices;

FIG. 3 illustrates a transaction diagram showing remote authentication;

FIG. 4 illustrate one embodiment of the invention for authenticating with a relying party;

FIG. 5 illustrates how a registration or authentication operation may be implemented with a query policy;

FIG. 6 illustrates one embodiment of a system for carrying strong authentication events over different channels;

FIG. 7 illustrates another embodiment of a system for carrying strong authentication events over different channels;

FIG. 8 illustrates another embodiment of a system for carrying strong authentication events over different channels;

FIG. 9 illustrates an embodiment of a system for carrying strong authentication events over a networking device with enhanced authentication;

FIG. 10 illustrates an embodiment of a method for carrying strong authentication events over different channels;

FIG. 11 illustrates an embodiment of a client and/or server computing device architecture; and

FIG. 12 illustrates another embodiment of a client and/or server computing device architecture.

### DETAILED DESCRIPTION OF PREFERRED EMBODIMENTS

Described below are embodiments of an apparatus, method, and machine-readable medium for implementing advanced authentication techniques and associated applications. Throughout the description, for the purposes of explanation, numerous specific details are set forth in order to provide a thorough understanding of the present invention. It will be apparent, however, to one skilled in the art that the present invention may be practiced without some of these specific details. In other instances, well-known structures and devices are not shown or are shown in a block diagram form to avoid obscuring the underlying principles of the present invention.

The embodiments of the invention discussed below involve authentication devices with user verification capabilities such as biometric modalities or PIN entry. These devices are sometimes referred to herein as “tokens,” “authentication devices,” or “authenticators.” While certain embodiments focus on facial recognition hardware/software (e.g., a camera and associated software for recognizing a user's face and tracking a user's eye movement), some embodiments may utilize additional biometric devices including, for example, fingerprint sensors, voice recognition hardware/software (e.g., a microphone and associated software for recognizing a user's voice), and optical recognition capabilities (e.g., an optical scanner and associated software for scanning the retina of a user). The user verification capabilities may also include non-biometric modalities, like PIN entry. The authenticators might use devices like trusted platform modules (TPMs), smartcards and secure elements for cryptographic operations and key storage.

In a mobile biometric implementation, the biometric device may be remote from the relying party. As used herein, the term “remote” means that the biometric sensor is not part of the security boundary of the computer it is communicatively coupled to (e.g., it is not embedded into the same physical enclosure as the relying party computer). By way of example, the biometric device may be coupled to the relying party via a network (e.g., the Internet, a wireless network link, etc) or via a peripheral input such as a USB port. Under these conditions, there may be no way for the relying party to know if the device is one which is authorized by the relying party (e.g., one which provides an acceptable level of authentication strength and integrity protection) and/or whether a hacker has compromised or even replaced the biometric device. Confidence in the biometric device depends on the particular implementation of the device.

The term “local” is used herein to refer to the fact that the user is completing a transaction in person, at a particular location such as at an automatic teller machine (ATM) or a point of sale (POS) retail checkout location. However, as discussed below, the authentication techniques employed to authenticate the user may involve non-location components such as communication over a network with remote servers and/or other data processing devices. Moreover, while specific embodiments are described herein (such as an ATM and retail location) it should be noted that the underlying principles of the invention may be implemented within the context of any system in which a transaction is initiated locally by an end user.

The term “relying party” is sometimes used herein to refer, not merely to the entity with which a user transaction is attempted (e.g., a Website or online service performing user transactions), but also to the secure transaction servers implemented on behalf of that entity which may performed the underlying authentication techniques described herein. The secure transaction servers may be owned and/or under the control of the relying party or may be under the control of a third party offering secure transaction services to the relying party as part of a business arrangement.

The term “server” is used herein to refer to software executed on a hardware platform (or across multiple hardware platforms) that receives requests over a network from a client, responsively performs one or more operations, and transmits a response to the client, typically including the results of the operations. The server responds to client requests to provide, or help to provide, a network “service” to the clients. Significantly, a server is not limited to a single computer (e.g., a single hardware device for executing the server software) and may, in fact, be spread across multiple hardware platforms, potentially at multiple geographical locations.

### Exemplary System Architectures

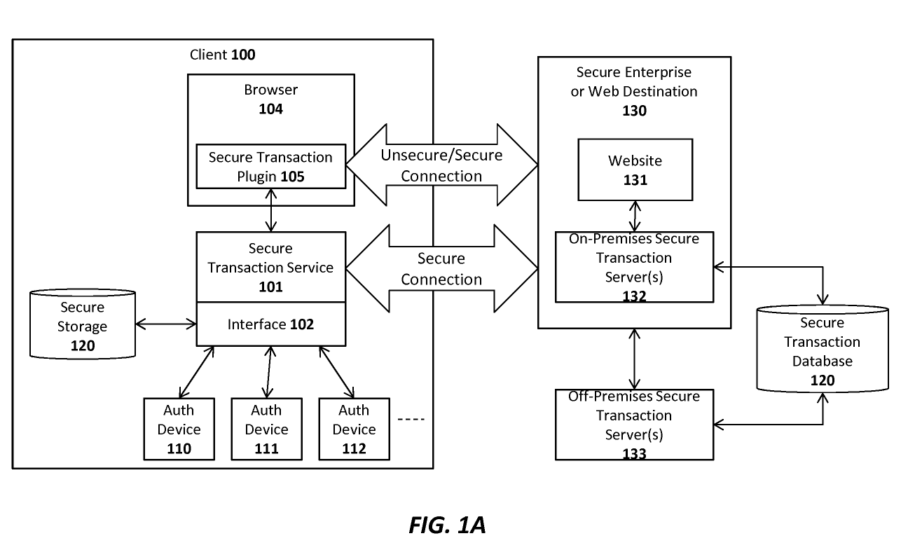

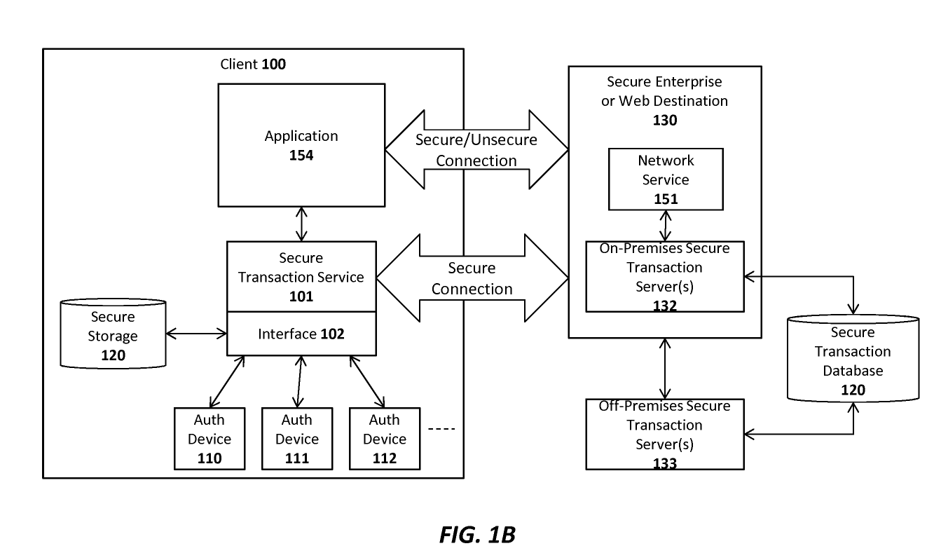

FIGS. 1A-B illustrate two embodiments of a system architecture comprising client-side and server-side components for authenticating a user. The embodiment shown in FIG. 1A uses a web browser plugin-based architecture for communicating with a website while the embodiment shown in FIG. 1B does not require a web browser. The various techniques described herein such as enrolling a user with authentication devices, registering the authentication devices with a secure server, and verifying a user may be implemented on either of these system architectures. Thus, while the architecture shown in FIG. 1A is used to demonstrate the operation of several of the embodiments described below, the same basic principles may be easily implemented on the system shown in FIG. 1B (e.g., by removing the browser plugin 105 as the intermediary for communication between the server 130 and the secure transaction service 101 on the client).

Turning first to FIG. 1A, the illustrated embodiment includes a client 100 equipped with one or more authentication devices 110-112 (sometimes referred to in the art as authentication “tokens” or “Authenticators”) for enrolling and verifying an end user. As mentioned above, the authentication devices 110-112 may include biometric device such as fingerprint sensors, voice recognition hardware/software (e.g., a microphone and associated software for recognizing a user's voice), facial recognition hardware/software (e.g., a camera and associated software for recognizing a user's face), and optical recognition capabilities (e.g., an optical scanner and associated software for scanning the retina of a user) and support for non-biometric modalities, such as PIN verification. The authentication devices might use trusted platform modules (TPMs), smartcards or secure elements for cryptographic operations and key storage.

The authentication devices 110-112 are communicatively coupled to the client through an interface 102 (e.g., an application programming interface or API) exposed by a secure transaction service 101. The secure transaction service 101 is a secure application for communicating with one or more secure transaction servers 132-133 over a network and for interfacing with a secure transaction plugin 105 executed within the context of a web browser 104. As illustrated, the Interface 102 may also provide secure access to a secure storage device 120 on the client 100 which stores information related to each of the authentication devices 110-112 such as a device identification code, user identification code, user enrollment data (e.g., scanned fingerprint or other biometric data) protected by he authentication device, and keys wrapped by the authentication device used to perform the secure authentication techniques described herein. For example, as discussed in detail below, a unique key may be stored into each of the authentication devices and used when communicating to servers 130 over a network such as the Internet.

As discussed below, certain types of network transactions are supported by the secure transaction plugin 105 such as HTTP or HTTPS transactions with websites 131 or other servers. In one embodiment, the secure transaction plugin is initiated in response to specific HTML tags inserted into the HTML code of a web page by the web server 131 within the secure enterprise or Web destination 130 (sometimes simply referred to below as “server 130”). In response to detecting such a tag, the secure transaction plugin 105 may forward transactions to the secure transaction service 101 for processing. In addition, for certain types of transactions (e.g., such as secure key exchange) the secure transaction service 101 may open a direct communication channel with the on-premises transaction server 132 (i.e., co-located with the website) or with an off-premises transaction server 133.

The secure transaction servers 132-133 are coupled to a secure transaction database 120 for storing user data, authentication device data, keys and other secure information needed to support the secure authentication transactions described below. It should be noted, however, that the underlying principles of the invention do not require the separation of logical components within the secure enterprise or web destination 130 shown in FIG. 1A. For example, the website 131 and the secure transaction servers 132-133 may be implemented within a single physical server or separate physical servers. Moreover, the website 131 and transaction servers 132-133 may be implemented within an integrated software module executed on one or more servers for performing the functions described below.

As mentioned above, the underlying principles of the invention are not limited to a browser-based architecture shown in FIG. 1A. FIG. 1B illustrates an alternate implementation in which a stand-alone application 154 utilizes the functionality provided by the secure transaction service 101 to authenticate a user over a network. In one embodiment, the application 154 is designed to establish communication sessions with one or more network services 151 which rely on the secure transaction servers 132-133 for performing the user/client authentication techniques described in detail below.

In either of the embodiments shown in FIGS. 1A-B, the secure transaction servers 132-133 may generate the keys which are then securely transmitted to the secure transaction service 101 and stored into the authentication devices within the secure storage 120. Additionally, the secure transaction servers 132-133 manage the secure transaction database 120 on the server side.

### Device Registration and Transaction Confirmation

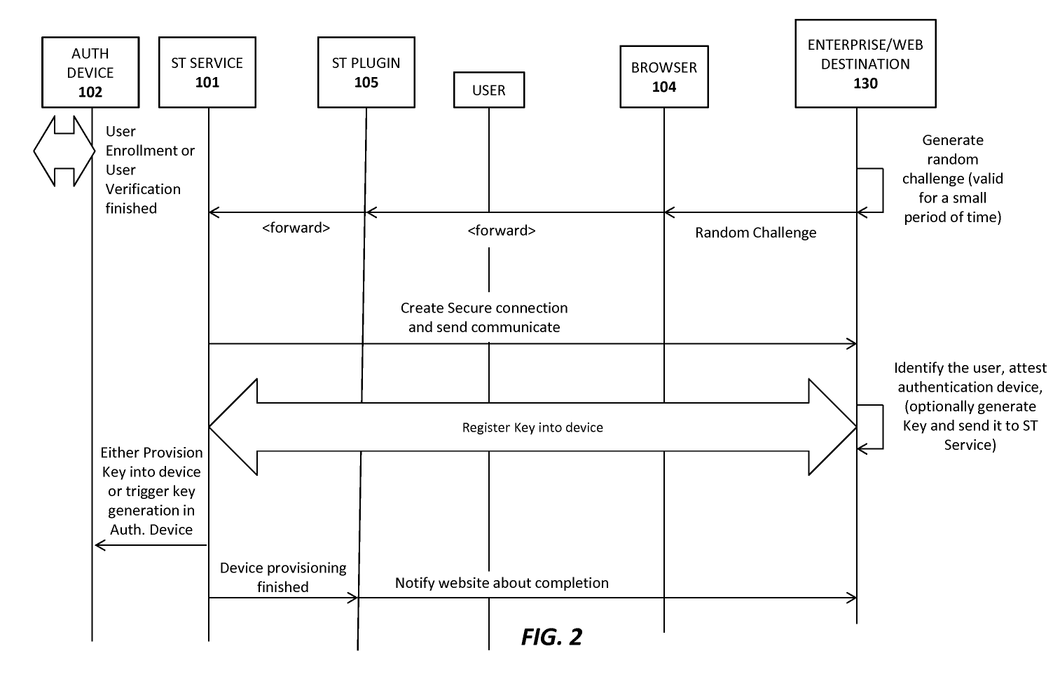

In one embodiment of the invention, strong authentication between a client and an authentication service is carried over different channels (e.g., to different relying parties). As such, certain basic principles associated with registering and authenticating with an authentication service will be described with respect to FIGS. 2-5, followed by a detailed description of embodiments of the invention for carrying strong authentication over different channels.

FIG. 2 illustrates a series of transactions for registering authentication devices. During registration, a key is shared between the authentication device and one of the secure transaction servers 132-133. The key is stored within the secure storage 120 of the client 100 and the secure transaction database 120 used by the secure transaction servers 132-133. In one embodiment, the key is a symmetric key generated by one of the secure transaction servers 132-133. However, in another embodiment discussed below, asymmetric keys may be used. In this embodiment, the public key may be stored by the secure transaction servers 132-133 and a second, related private key may be stored in the secure storage 120 on the client. Moreover, in another embodiment, the key(s) may be generated on the client 100 (e.g., by the authentication device or the authentication device interface rather than the secure transaction servers 132-133). The underlying principles of the invention are not limited to any particular types of keys or manner of generating the keys.

A secure key provisioning protocol such as the Dynamic Symmetric Key Provisioning Protocol (DSKPP) may be used to share the key with the client over a secure communication channel (see, e.g., Request for Comments (RFC) 6063). However, the underlying principles of the invention are not limited to any particular key provisioning protocol.

Turning to the specific details shown in FIG. 2, once the user enrollment or user verification is complete, the server 130 generates a randomly generated challenge (e.g., a cryptographic nonce) that must be presented by the client during device registration. The random challenge may be valid for a limited period of time. The secure transaction plugin detects the random challenge and forwards it to the secure transaction service 101. In response, the secure transaction service initiates an out-of-band session with the server 130 (e.g., an out-of-band transaction) and communicates with the server 130 using the key provisioning protocol. The server 130 locates the user with the user name, validates the random challenge, validates the device's authentication code if one was sent, and creates a new entry in the secure transaction database 120 for the user. It may also generate the key, write the key to the database 120 and send the key back to the secure transaction service 101 using the key provisioning protocol. Once complete, the authentication device and the server 130 share the same key if a symmetric key was used or different keys if asymmetric keys were used.

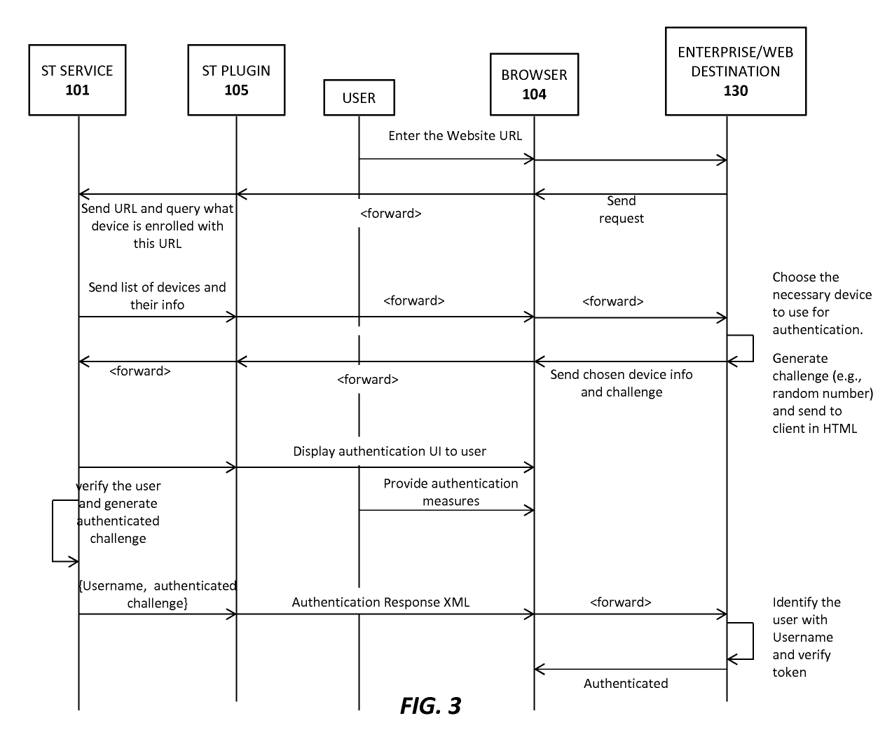

FIG. 3 illustrates a series of transactions for user authentication with the registered authentication devices. Once device registration is complete the server 130 will accept a token generated by the local authentication device as a valid authentication token.

Turning to the specific details shown in FIG. 3, which shows a browser-based implementation, the user enters the uniform resource locator (URL) of the server 130 in the browser 104. In an implementation which uses a stand alone application or mobile device app (rather than a browser), the user may enter a network address for a network service or the application or app may automatically attempt to connect to the network service at the network address.

For a browser-based implementation, the website embeds a query for registered devices in the HTML page. This may be done in many ways other than embedding the query in an HTML page, such as through Javascript or using HTTP headers. The secure transaction plugin 105 receives the URL and sends it to secure transaction service 101, which searches the looks into the secure storage 120 (which, as discussed, includes a database of authentication device and user information) and determines whether there is a user enrolled within this URL. If so, the secure transaction service 101 sends a list of provisioned devices associated with this URL to the secure transaction plugin 105. The secure transaction plugin then calls the registered JavaScript API and passes this information to the server 130 (e.g., the website). The server 130 chooses the appropriate device from the sent device list, generates a random challenge and sends the device information, and argument back to the client. The website displays the corresponding user interface and asks for authentication from the user. The user then provides the requested authentication measure (e.g., swiping a finger across the fingerprint reader, speaking for voice recognition, etc). The secure transaction service 101 identifies the user (this step can be skipped for devices which don't support storing users), obtains the username from the database, generates an authentication token using the key and sends this information to the website via the secure transaction plugin. The server 130 identifies the user from the secure transaction database 120 and verifies the token by generating the same token on the server 130 (e.g., using its copy of the key). Once verified, the authentication process is complete.

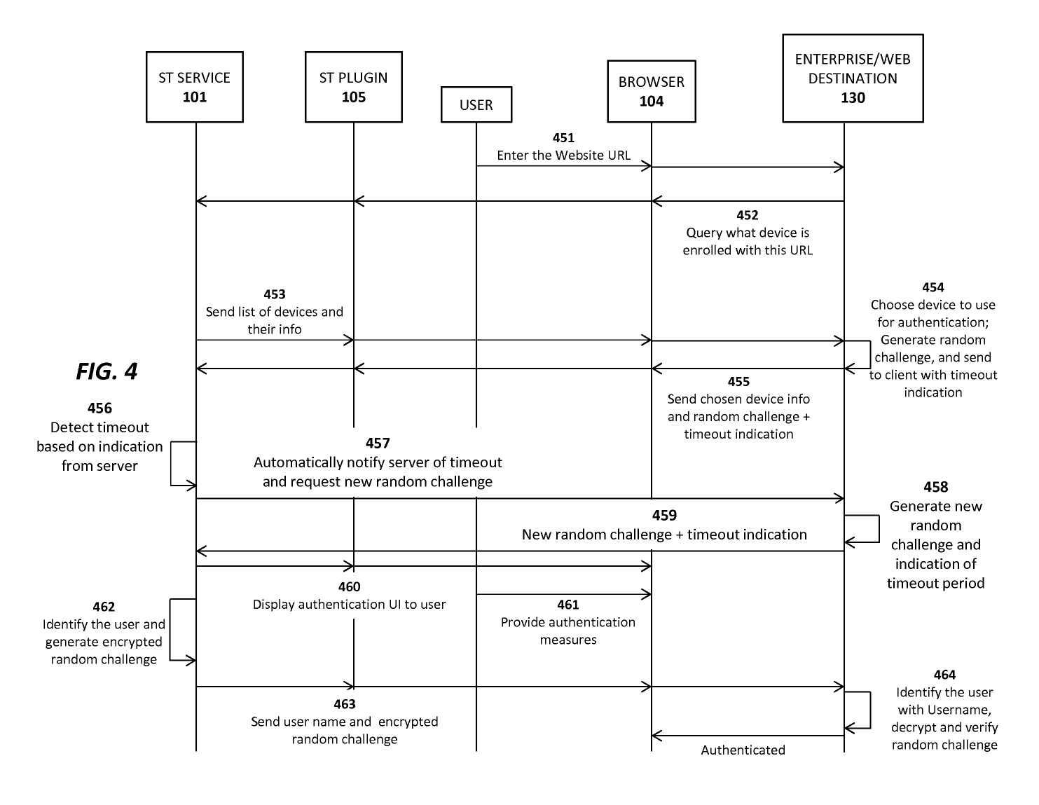

FIG. 4 illustrates another embodiment of authentication process in which the client automatically detects that the challenge has expired and transparently requests a new challenge from the server (i.e., without user intervention). The server then generates a new random challenge and transmits it to the client which may then use it to establish secure communication with the server. The end user experience is improved because the user does not receive an error or denial of an authentication request.

At 451, the user enters a particular website URL into the browser 104 and is directed to the web server 131 within the enterprise/web destination servers 130 which includes the secure transaction servers 132-133. At 452, a query is sent back to the secure transaction service (via the browser and plugin) to determine which device(s) are registered with the website's URL. The secure transaction service 101 queries the secure storage 720 on the client 100 to identify a list of devices which are sent back to the server 130 at 453. At 454, the server 454 chooses a device to use for authentication, generates a random challenge and a timeout indication and, at 455, sends this information back to the secure transaction service 101.

At 456, the secure transaction service 456 automatically detects that the random challenge is no longer valid upon reaching the end of the timeout period. Various different techniques may be employed for indicating and detecting the end of the timeout period. In one embodiment, the timeout period comprises a period of time for which the random challenge is considered valid. After the timeout period has elapsed, the random challenge is no longer considered valid by the server 130. In one embodiment, the timeout period is specified simply as a point in time at which the random challenge will no longer be valid. Once this point in time is reached, the random challenge is invalid. In another embodiment, the timeout period is specified by using a current timestamp (i.e., the time at which the random challenge is generated by the server 130) and a duration. The secure transaction service 101 may then calculate the timeout time by adding the duration value to the timestamp to calculate the point in time when the random challenge becomes invalid. It should be noted, however, that the underlying principles of the invention are not limited to any specific technique for calculating the timeout period.

Upon detecting the expiration of the random challenge, at 457, the secure transaction service 101 transparently (i.e., without user intervention) notifies the server 130 and requests a new random challenge. In response, at 458, the server 130 generates a new random challenge and a new indication of the timeout period. As mentioned, the new timeout period may be the same as previously sent to the client or may be modified. In either case, at 459, the new random challenge and timeout indication are sent to the secure transaction service 101.

The remainder of the transaction diagram shown in FIG. 4 operates in substantially the same manner as described above (see, e.g., FIG. 3). For example, at 460, an authentication user interface is displayed (e.g., directing the user to swipe a finger on a fingerprint sensor) and, at 461, the user provides authentication (e.g., swipes a finger on the fingerprint scanner). At 462, the secure transaction service verifies the identity of the user (e.g., comparing the authentication data collected from the user with that stored in the secure storage 720) and uses the key associated with the authentication device to encrypt the random challenge. At 463, the user name (or other ID code) and the encrypted random challenge are sent to the server 130. Finally, at 464, the server 130 identifies the user within the secure transaction database 120 using the user name (or other ID code), and decrypts/verifies the random challenge using the key stored in the secure transaction database 120 to complete the authentication process.

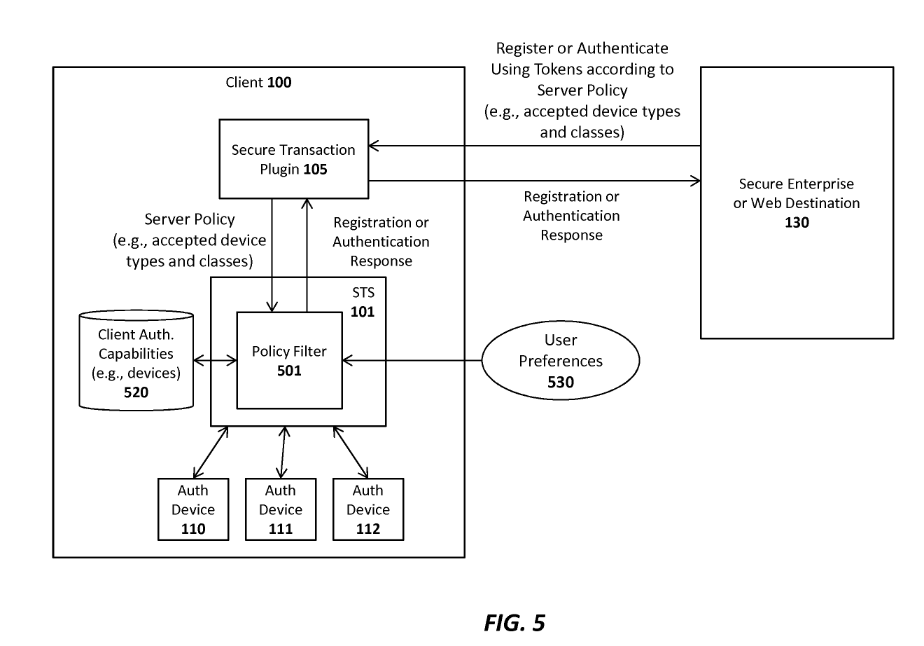

FIG. 5 illustrates one embodiment of a client-server architecture for implementing these techniques. As illustrated, the secure transaction service 101 implemented on the client 100 includes a policy filter 401 for analyzing the policy provided by the server 130 and identifying a subset of authentication capabilities to be used for registration and/or authentication. In one embodiment, the policy filter 401 is implemented as a software module executed within the context of the secure transaction service 101. It should be noted, however, that the policy filter 401 may be implemented in any manner while still complying with the underlying principles of the invention and may include software, hardware, firmware, or any combination thereof.

The particular implementation shown in FIG. 5 includes a secure transaction plugin 105 for establishing communication with the secure enterprise or Web destination 130 (sometimes referred to simply as “server 130” or “relying party” 130) using techniques previously discussed. For example, the secure transaction plugin may identify a specific HTML tag inserted into the HTML code by a web server 131. Thus, in this embodiment, the server policy is provided to the secure transaction plugin 105 which forwards it to the secure transaction service 101 implementing the policy filter 501.

The policy filter 501 may determine the client authentication capabilities by reading the capabilities from the client's secure storage area 520. As previously discussed, the secure storage 520 may comprise a repository of all of the client's authentication capabilities (e.g., identification codes for all of the authentication devices). If the user has already enrolled the user with its authentication devices, the user's enrollment data is stored within the secure storage 520. If the client has already registered an authentication device with a server 130, then the secure storage may also store an encrypted secret key associated with each authentication device.

Using the authentication data extracted from the secure storage 520 and the policy provided by the server, the policy filter 501 may then identify a subset of authentication capabilities to be used. Depending on the configuration, the policy filter 501 may identify a complete list of authentication capabilities supported by both the client and the server or may identify a subset of the complete list. For example, if the server supports authentication capabilities A, B, C, D, and E and the client has authentication capabilities A, B, C, F, and G, then the policy filter 501 may identify the entire subset of common authentication capabilities to the server: A, B, and C. Alternatively, if a higher level of privacy is desired, as indicated by user preferences 530 in FIG. 5, then a more limited subset of authentication capabilities may be identified to the server. For example, the user may indicate that only a single common authentication capability should be identified to the server (e.g., one of A, B or C). In one embodiment, the user may establish a prioritization scheme for all of the authentication capabilities of the client 100 and the policy filter may select the highest priority authentication capability (or a prioritized set of N authentication capabilities) common to both the server and the client.

Depending on what operation has been initiated by server 130 (Registration or Authentication), the secure transaction service 130 performs that operation on the filtered subset of authentication devices (110-112) and sends the operation response back to server 130 via the secure transaction plugin 105 as shown in FIG. 5. Alternatively, in an embodiment which does not rely on a plugin 105 component of a Web browser, the information may be passed directly from the secure transaction service 101 to the server 130.

### System and Method for Carrying Strong Authentication Over Different Channels

In one embodiment, the relying party may receive a cryptographic proof of the authenticator model used for authentication from which it can derive the security characteristics for the authenticator model. A relying party web application, for example, may use the derived security characteristics. For example a bank might only display the account status if the authentication assurance level is medium and it might allow financial transactions only if the authentication assurance level is high. As another example, corporations may grant access to email only if the authentication assurance level is medium and may grant access to a confidential file repository only if the authentication assurance level is high.

What is considered a “medium assurance level” or “high assurance level” depends on the region and the vertical. Financial institutions in the US have to comply with different regulations than the financial institutions in the European Union (EU), in Africa, and in Asia. E-Commerce web sites again have to comply with different (or sometimes no) regulations with respect to the authentication assurance level. But those institutions typically have their own idea or even formal policy about what is considered an acceptable assurance level for certain transactions. Examples of formal definitions exist (see, e.g., SP-800-623-2 established for US Federal Agencies). Sometimes such policies include the definition of Identification strength (e.g., such as the “know your customer” (KYC) policy). Such identification strength is even more specific to regions and verticals.

Real world relying parties often have complex computing and networking infrastructures. Sometime the relying parties (a) may not want to operate such authentication servers in their own data centers or (b) may want to centralize the authentication in one place and then send the authenticated data through a protected network to the final Web Service.

To address these needs, in one embodiment, a client device attempting to access one or more Web services offered by a relying party, initially authenticates with a dedicated authentication server/service. In response to a successful authentication, the authentication server transmits an authentication token to the client device which includes proof of the successful authentication. In one embodiment, the token comprises a signature generated over both the identity of the user and the identity of the Web service which the user is attempting to access (e.g., User “John Doe” and Web service “XYZ”). The client device then presents the token to the Web service as proof that the user has successfully authenticated.

In one embodiment, the client device also provides details related to the authentication device(s) used to authenticate the user to the Web service, either included within the token or sent separately from the token. For example, the client device may provide an identifier uniquely identifying the type of authenticator used to authenticate the user such as an Authenticator Attestation ID (AAID). In this embodiment, each distinct authenticator type used in a client device may be identified by its AAID. The relying party may then use the AAID to identify the authenticator type and implement authentication policies based on the type of authenticator used.

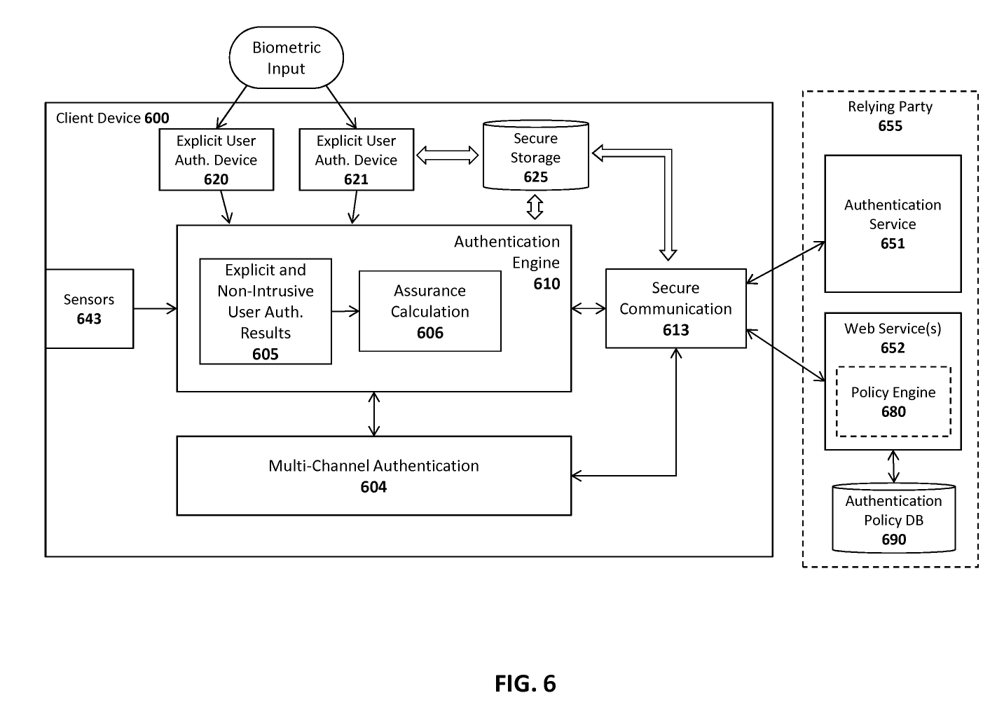

FIG. 6 illustrates an exemplary client device 600 on which embodiments of the invention may be implemented. In particular, this embodiment includes a multi-channel authentication module 604 for coordinating authentication with the authentication service 651, receiving the token, and the presenting the token (and other information) to the Web service 652 in response to a successful authentication. The illustrated embodiment also includes an authentication engine 610 with an assurance calculation module 606 for generating an assurance level that the legitimate user is in possession of the client device 600. For example, explicit and non-intrusive authentication results 605 are gathered using explicit user authentication devices 620-621, one or more sensors 643 (e.g., location sensors, accelerometers, etc), and other data related to the current authentication state of the client device 600 (e.g., such as the time since the last explicit authentication). Although illustrated as separate modules in FIG. 6, the authentication engine 610 and multi-channel authentication module 604 may be implemented as a single module for performing all of the operations described herein.

Explicit authentication may be performed, for example, using biometric techniques (e.g., swiping a finger on a fingerprint authentication device, capturing a photo, etc) and/or by the user entering a secret code. Non-intrusive authentication techniques may be performed based on data such as the current detected location of the client device 600 (e.g., via a GPS sensor), other sensed user behavior (e.g., measuring the gait of the user with an accelerometer), and/or variables such as the time since the last explicit authentication. Regardless of how the authentication results 605 are generated, the assurance calculation module 606 may use the results to determine an assurance level indicating a likelihood that the legitimate user 650 is in possession of the client device 600. In one embodiment, instead of generating an assurance level, the authentication engine 610 may simply determine whether the authentication results are sufficient to authenticate the user (e.g., above a specified threshold based on explicit and/or implicit authentication results). If so, then authentication is successful; if not, then authentication is not successful, and/or additional authentication is requested.

A secure communication module 613 establishes secure communication with the authentication service to provide results of the authentication. For example, if the authentication level is above a specified threshold, then the user may successfully be authenticated to the relying party relying party 613 (e.g., using a secure encryption key as discussed herein). Public/private key pairs or symmetric keys may be stored within a secure storage device 625 which may be implemented as a cryptographically secure hardware device (e.g., a security chip) or using any combination of secure hardware and software.

In one embodiment, in response to a successful authentication using the authentication engine 610, the authentication service 651 transmits the token to the multi-channel authentication module 604. As mentioned above, the token may include a signature generated over both the identity of the user and the identity of the Web service which the user is attempting to access. The multi-channel authentication module 604 then presents the token to the Web service(s) 652 as proof that the user has successfully authenticated. In addition, the multi-channel authentication module 604 may provide details related to the authentication device(s) used to authenticate the user (e.g., the AAID(s) of the device(s)).

In one embodiment, the Web service 652 uses the details such as the AAID to query an authentication policy database 690 and implement an authentication policy based on the details. In one embodiment, the authentication policy database 960 includes metadata for all existing authentication devices, classes of authentication devices, classes of interactions, and authentication rules (examples of which are discussed below). In general, each relying party may implement its own authentication policy using internal risk calculations based on historic transactions and/or known device capabilities.

The metadata for existing devices, for example, may be specified as defined by the Fast Identity Online Alliance specifications (e.g., as [FIDOUAFMetadata]); however, the underlying principles of the invention are not related to any particular type of metadata. The metadata may include specific model information and data related to the reliability and accuracy of each authentication device. For example, an entry for a “Validity Model 123” fingerprint sensor may include technical details related to this sensor such as the manner in which the sensor stores sensitive data (e.g., in cryptographically secure hardware, EAL 3 certification, etc) and the false acceptance rate (indicating how reliable the sensor is when generating a user authentication result).

In one embodiment, the authentication device classes specified in the database 690 may logically group authentication devices based on the capabilities of those devices. For example, one particular authentication device class may be defined for (1) fingerprint sensors (2) that store sensitive data in cryptographically secure hardware that has been EAL 3 certified, and (3) that use a biometric matching process with a false acceptance rate less than 1 in 1000. Another exemplary device class may be (1) facial recognition devices (2) which do not store sensitive data in cryptographically secure hardware, and (3) that use a biometric matching process with a false acceptance rate less than 1 in 500. Thus, a fingerprint sensor or facial recognition implementation which meets the above criteria will be added to the appropriate authentication device class(es) within the database 690.

Various individual attributes may be used to define authentication device classes, such as the type of authentication factor (fingerprint, PIN, face, for example), the level of security assurance of the hardware, the location of storage of secrets, the location where cryptographic operations are performed by the authenticator (e.g., in a secure chip or Secure Enclosure), and a variety of other attributes. Another set of attributes which may be used are related to the location on the client where the “matching” operations are performed. For example, a fingerprint sensor may implement the capture and storage of fingerprint templates in a secure storage on the fingerprint sensor itself, and perform all validation against those templates within the fingerprint sensor hardware itself, resulting in a highly secure environment. Alternatively, the fingerprint sensor may simply be a peripheral that captures images of a fingerprint, but uses software on the main CPU to perform all capture, storage, and comparison operations, resulting in a less secure environment. Various other attributes associated with the “matching” implementation may also be used to define the authentication device classes (e.g., whether the matching is (or is not) performed in a secure element, trusted execution environment (TEE)), or other form of secure execution environment).

Of course, these are merely examples for illustrating the concept of authentication device classes. Various additional authentication device classes may be specified while still complying with the underlying principles. Moreover, it should be noted that, depending on how the authentication device classes are defined, a single authentication device may be categorized into multiple device classes.

In one embodiment, the policy database 690 may be updated periodically to include data for new authentication devices as they come to market as well as new authentication device classes, potentially containing new classes into which the new authentication devices may be classified. The updates may be performed by the relying party and/or by a third party responsible for providing the updates for the relying party (e.g., a third party who sells the secure transaction server platforms used by the relying party).

In one embodiment, interaction classes are defined based on the particular transactions offered by the relying party. For example, if the relying party is a financial institution, then interactions may be categorized according to the monetary value of the transaction. A “high value interaction” may be defined as one in which an amount of $5000 or more is involved (e.g., transferred, withdrawn, etc); a “medium value interaction” may be defined as one in which an amount between $500 and $4999 is involved; and a “low value transaction” may be defined as one in which an amount of $499 or less is involved (or one which does not involve a monetary transaction).

In addition to the amount of money involved, interaction classes may be defined based on the sensitivity of the data involved. For example, transactions disclosing a user's confidential or otherwise private data may be classified as “confidential disclosure interactions” whereas those which do not disclose such data may be defined as “non-confidential disclosure interactions.” Various other types of interactions may be defined using different variables and a variety of minimum, maximum, and intermediate levels.

Finally, a set of authentication rules may be defined which involve the authentication devices, authentication device classes, and/or interaction classes. By way of example, and not limitation, a particular authentication rule may specify that for “high value transactions” (as specified by an interaction class) only fingerprint sensors that store sensitive data in cryptographically secure hardware that has been EAL 3 certified, and that use a biometric matching process with a false acceptance rate less than 1 in 1000 (as specified as an authentication device class) may be used. If a fingerprint device is not available, the authentication rule may define other authentication parameters that are acceptable. For example, the user may be required to enter a PIN or password and also to answer a series of personal questions (e.g., previously provided by the user to the relying party). Any of the above individual attributes specified for authentication devices and/or authentication device classes may be used to define the rules, such as the type of authentication factor (fingerprint, PIN, face, for example), the level of security assurance of the hardware, the location of storage of secrets, the location where cryptographic operations are performed by the authenticator.

Alternatively, or in addition, a rule may specify that certain attributes can take on any value, as long as the other values are sufficient. For example, the relying party may specify that a fingerprint device must be used which stores its seed in hardware and performs computations in hardware, but does not care about the assurance level of the hardware (as defined by an authentication device class containing a list of authentication devices meeting these parameters).

Moreover, in one embodiment, a rule may simply specify that only specific authentication devices can be used for authenticating a particular type of interaction. For example, the organization can specify that only a “Validity Model 123 fingerprint sensor” is acceptable for a High Value Transaction.

In addition, a rule or set of rules may be used to create ordered, ranked combinations of authentication policies for an interaction. For example, the rules may specify combinations of policies for individual authentication policies, allowing the creation of rich policies that accurate reflect the authentication preferences of the relying party. This would allow, for example, the relying party to specify that fingerprint sensors are preferred, but if none is available, then either trusted platform module (TPM)-based authentication or face recognition are equally preferable as the next best alternatives (e.g., in a prioritized order).

In one embodiment, an authentication policy engine 680 implements the authentication rules, relying on the interaction classes, authentication device classes, and/or authentication device data, when determining whether to permit a transaction with the client 600. For example, in response to the user of the client device 600 attempting to enter into a transaction with the Web service 652, the authentication policy engine 690 may identify a set of one or more interaction classes and associated authentication rules which are applicable. It may then apply these rules to determine whether the token provided by the multi-channel authentication module 604 is sufficient. If the token is sufficient (e.g., if an acceptable authentication device was used for the current transaction), then the client device 600 is permitted to perform the transaction with the Web service 652. If not, then the transaction is denied and/or additional authentication is requested.

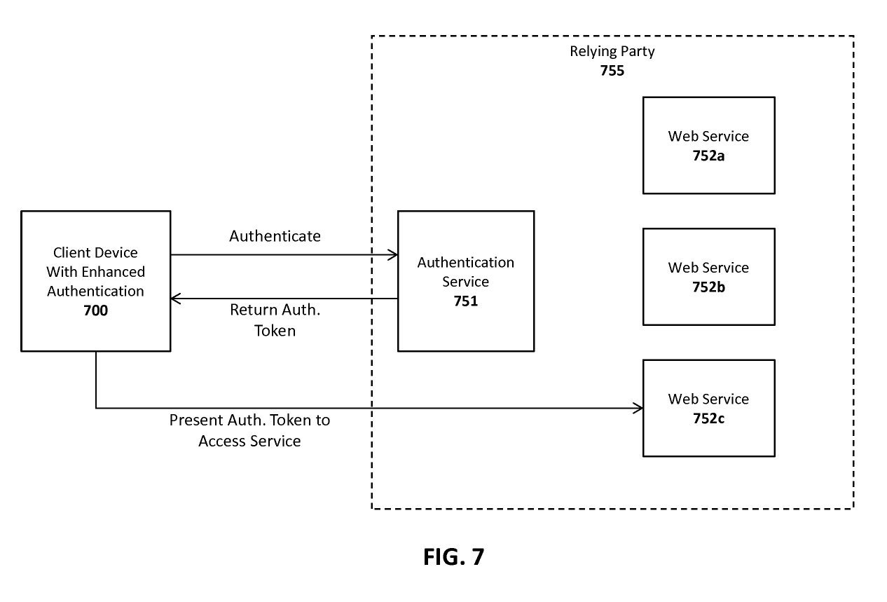

Architectural implementations for three different embodiments of the invention are illustrated in FIGS. 7-9. In the embodiment shown in FIG. 7, a client device with enhanced authentication capabilities 700 (e.g., such as the client devices described above) authenticates with a dedicated authentication service 751 (e.g., one or more authentication servers) at the relying party 755. The relying party 755 includes a plurality of Web services 752a-c. If authentication is successful, the authentication service 751 returns the authentication token to the client device 700 comprising a signature over the identity of the user/client device and the Web service 752c. In addition, as mentioned, the token may include the identity of the type of authenticator(s) used during authentication. The client device 700 then presents the token to the Web service 752c to initiate a transaction. Assuming that the authentication device used is acceptable (e.g., within an acceptable device class for the desired transaction), then the Web service 752c allows the transaction.

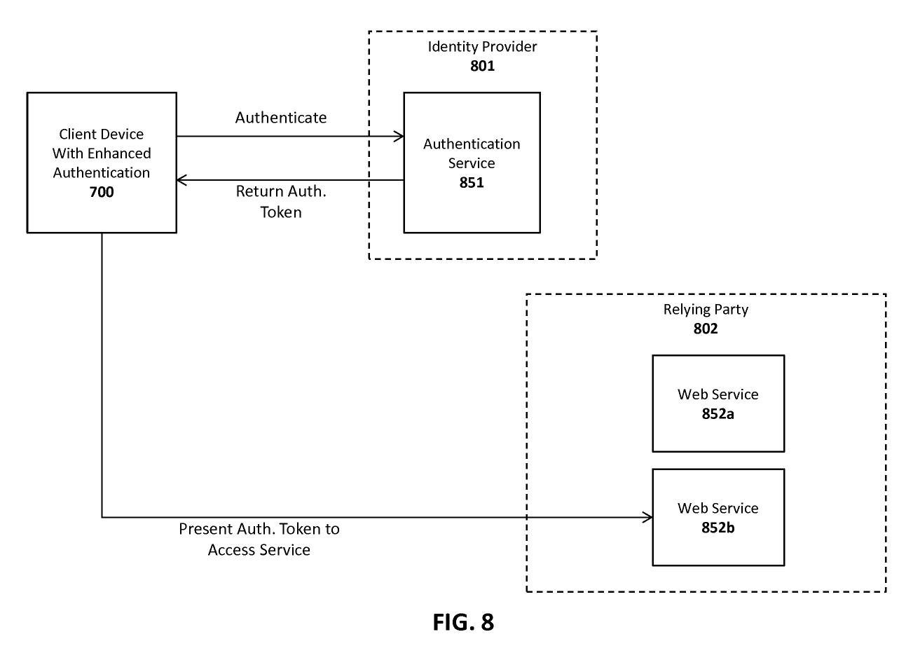

FIG. 8 illustrates an embodiment in which the relying party uses an external identify provider 801 with an authentication service 851 for authenticating the user. In this embodiment, the relying party 802 relies on the authentication performed by the identity provider 801 prior to providing Web services 852a-b to the client 600. As in the embodiment shown in FIG. 7, a client device with enhanced authentication capabilities 700 authenticates with a dedicated authentication service 851 managed by the identity provider 801. If authentication is successful, the authentication service 851 returns the authentication token to the client device 700 comprising a signature over the identity of the user/client device and the Web service 852b. In addition, as mentioned, the token may include the identity of the type of authenticator(s) used during authentication. The client device 700 then presents the token to the Web service 852b to initiate a transaction. Assuming that the authentication device used is acceptable (e.g., within an acceptable device class for the desired transaction), then the Web service 852b allows the transaction.

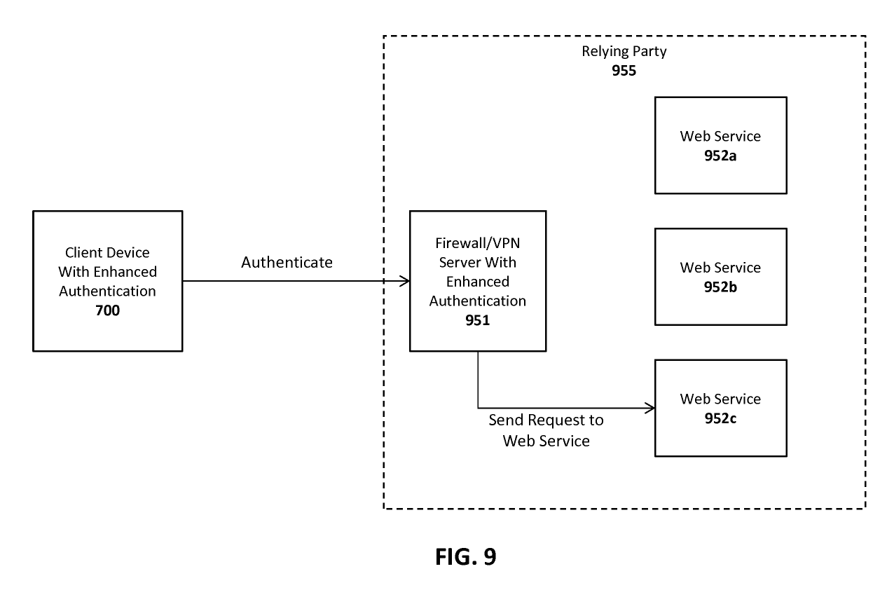

FIG. 9 illustrates an embodiment in which the relying party 955 authenticates a the network layer device 951 such as a firewall, virtual private network (VPN) device, or transport layer security (TLS) concentrator, which includes enhanced authentication services. As in prior embodiments, the client device with enhanced authentication capabilities 700 is provided with access to a web service 952c in response to a successful authentication. In contrast to prior embodiments, the authentication device 951 does not provide a token with a back to the client 700 which the client then uses to access the Web service 952c. Rather, in this embodiment, all authentication is performed at the network layer (e.g., the IP packet layer in a TCP/IP network) and the network layer device 951 connects the client 700 directly to the Web service 952c (e.g., because all network traffic between the client 700 and relying party 955 flows through the network layer device 951).

In one embodiment, if the client deice 700 successfully authenticates, the network layer packets to/from the client may tagged with the related authentication security characteristic identifier (e.g., an identifier of the authenticator such as an AAID as discussed above). For example, in one embodiment, each AAID is mapped to a 12-bit virtual identifier (VID) and each packet to/from the client is tagged with the VID. For example, a network standard such as IEEE 802.1Q may be used that supports virtual LANs (VLANs) on an Ethernet network and provides support for such tagging.

Alternatively, in one embodiment, the tagging is done on a higher level protocol such as HTTP. This is especially interesting if the authentication server 951 also acts as TLS endpoint (e.g. a TLS concentrator). In this case, a new header field may be added to include the AAID of the authentication device (e.g., a string data type containing the AAID). This field contains the AAID which is related to the authenticator 951 used by the user. In this case the network device ensures that such header field will never be passed through directly from incoming traffic.

In the above embodiments, the authentication servers 751, 851, 951 may offer an additional web service interface allowing the Web services 752, 852, 952 to request the security characteristics. One potential disadvantage of this approach is the increased load on the authentication servers (i.e., an additional request to the servers) and on the network (due to additional traffic).

Thus, instead of trying to define a (relatively small) number of discrete assurance levels (which can only be optimized for a specific region and vertical) and trying to include a description of all relevant aspects of the security characteristic, the above embodiments provide a universal method of identifying the relevant security characteristics and leave it to the market in general and the relying parties 755, 802, 955, in particular to determine the meaning for their individual regulations or policies.

Moreover, instead of requiring each Web Service to directly access the Authentication Server, in the embodiments discussed above the Authentication Server creates an authenticated data structure containing the relevant security characteristics (e.g., a token). The Web Service then verifies this data structure and can make decisions based on its contents. An identifier for the authentication security characteristic (e.g., an AAID) may be added in an authenticated way to the traffic/message.

In the case of an infrastructure such as shown in FIG. 9, the data structure may not need to be explicitly authenticated, as the network traffic behind such Firewall/VPN Server 951 (i.e., in a DMZ) is typically considered “secure”. This means the network channel itself guarantees that only authenticated traffic is sent into it.

Various different integration options are contemplated to integrate the embodiments of the invention into existing authentication protocols (e.g., such as the protocols described in the co-pending applications and the current FIDO standard). For example, when using the Security Assertion Markup Language (SAML) federation protocol, the authentication security characteristic identifier can be added to the authentication context as described, for example, in Authentication Context for the OASIS Security Assertion Markup Language (SAML) V2.0 (15 Mar. 2005). When using OpenID Connect, the authentication security characteristic identifier can be added to Authentication Method References (AMR) which is part of the ID Token, as discussed in Section 3.2.2.10 and 3.2.2.11 of OpenID Connect Core 1.0-draft 17 (3 Feb. 2014).

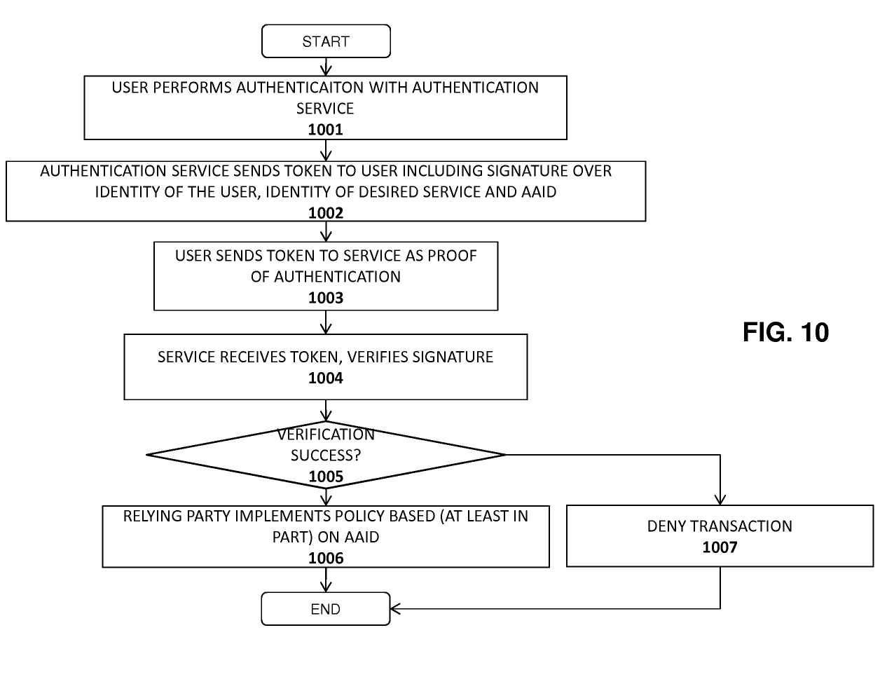

FIG. 10 illustrates a method in accordance with one embodiment of the invention. At 1001, the user performs remote authentication with an authentication service. In one embodiment, the user may be redirected to the authentication service upon attempting to initiate a transaction with a relying party. At 1002, once the user successfully authenticates (e.g., using any of the techniques described herein or other authentication techniques), the authentication service generates and sends a token to the user which includes a signature over an identifiers for the user and the service and the authenticator ID (e.g., the AAID). At 1003, the user sends the token to the service as proof of successful authentication. The service then verifies the signature on the token and, if the verification is successful, determined at 1005, then at 1006, the relying party implements a policy which is based, at least in part, on the identity of the authenticator used for authentication (e.g., by querying the policy database with the AAID). For example, as discussed above, policies may be implemented to allow certain transactions only for certain authenticators or classes of authenticators. If verification fails at 1005, then the transaction is denied at 1007.

### Exemplary Data Processing Devices

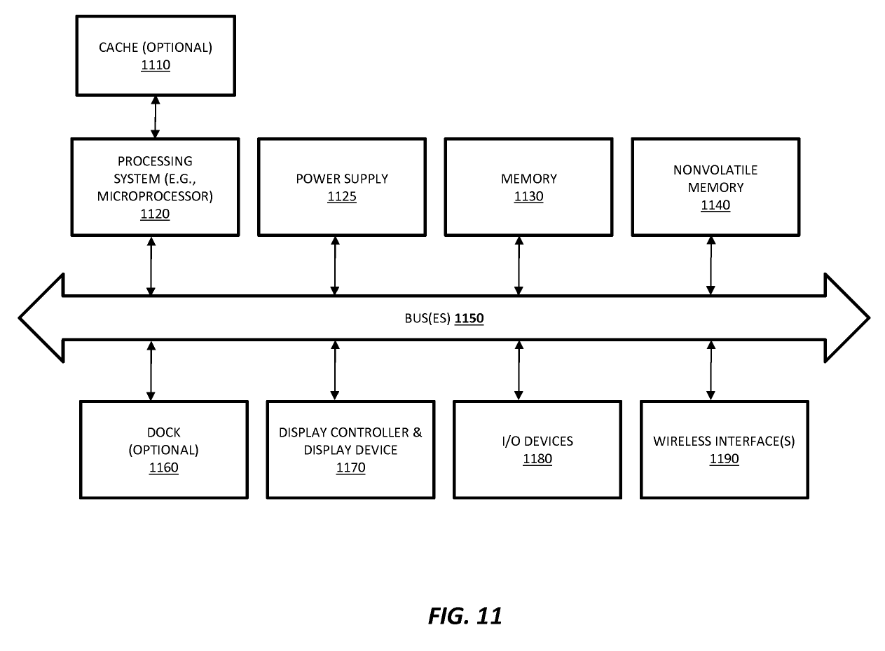

FIG. 11 is a block diagram illustrating an exemplary clients and servers which may be used in some embodiments of the invention. It should be understood that while FIG. 11 illustrates various components of a computer system, it is not intended to represent any particular architecture or manner of interconnecting the components as such details are not germane to the present invention. It will be appreciated that other computer systems that have fewer components or more components may also be used with the present invention.

As illustrated in FIG. 11, the computer system 1100, which is a form of a data processing system, includes the bus(es) 1150 which is coupled with the processing system 1120, power supply 1125, memory 1130, and the nonvolatile memory 1140 (e.g., a hard drive, flash memory, Phase-Change Memory (PCM), etc.). The bus(es) 1150 may be connected to each other through various bridges, controllers, and/or adapters as is well known in the art. The processing system 1120 may retrieve instruction(s) from the memory 1130 and/or the nonvolatile memory 1140, and execute the instructions to perform operations as described above. The bus 1150 interconnects the above components together and also interconnects those components to the optional dock 1160, the display controller & display device 1170, Input/Output devices 1180 (e.g., NIC (Network Interface Card), a cursor control (e.g., mouse, touchscreen, touchpad, etc.), a keyboard, etc.), and the optional wireless transceiver(s) 1190 (e.g., Bluetooth, WiFi, Infrared, etc.).

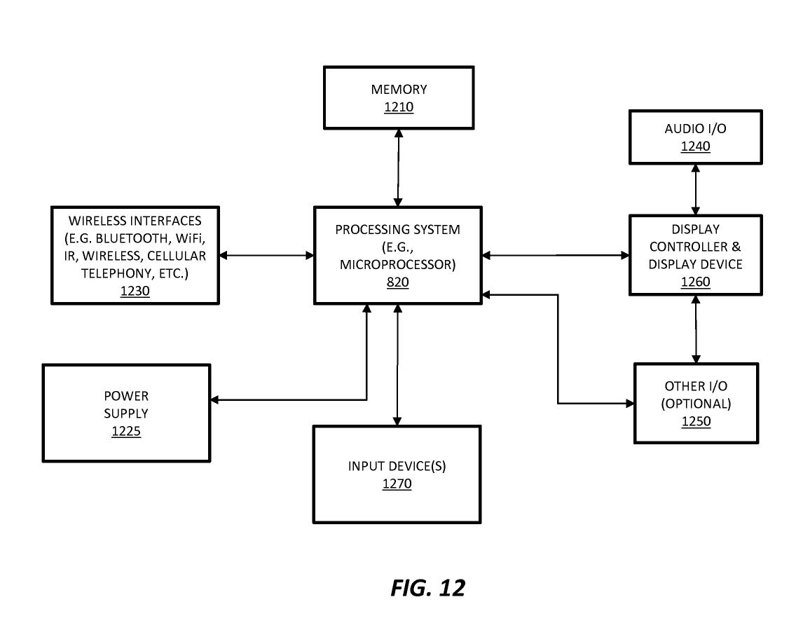

FIG. 12 is a block diagram illustrating an exemplary data processing system which may be used in some embodiments of the invention. For example, the data processing system 1200 may be a handheld computer, a personal digital assistant (PDA), a mobile telephone, a portable gaming system, a portable media player, a tablet or a handheld computing device which may include a mobile telephone, a media player, and/or a gaming system. As another example, the data processing system 1200 may be a network computer or an embedded processing device within another device.

According to one embodiment of the invention, the exemplary architecture of the data processing system 1200 may used for the mobile devices described above. The data processing system 1200 includes the processing system 1220, which may include one or more microprocessors and/or a system on an integrated circuit. The processing system 1220 is coupled with a memory 1210, a power supply 1225 (which includes one or more batteries) an audio input/output 1240, a display controller and display device 1260, optional input/output 1250, input device(s) 1270, and wireless transceiver(s) 1230. It will be appreciated that additional components, not shown in FIG. 12, may also be a part of the data processing system 1200 in certain embodiments of the invention, and in certain embodiments of the invention fewer components than shown in FIG. 12 may be used. In addition, it will be appreciated that one or more buses, not shown in FIG. 12, may be used to interconnect the various components as is well known in the art.

The memory 1210 may store data and/or programs for execution by the data processing system 1200. The audio input/output 1240 may include a microphone and/or a speaker to, for example, play music and/or provide telephony functionality through the speaker and microphone. The display controller and display device 1260 may include a graphical user interface (GUI). The wireless (e.g., RF) transceivers 1230 (e.g., a WiFi transceiver, an infrared transceiver, a Bluetooth transceiver, a wireless cellular telephony transceiver, etc.) may be used to communicate with other data processing systems. The one or more input devices 1270 allow a user to provide input to the system. These input devices may be a keypad, keyboard, touch panel, multi touch panel, etc. The optional other input/output 1250 may be a connector for a dock.

Embodiments of the invention may include various steps as set forth above. The steps may be embodied in machine-executable instructions which cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable program code. The machine-readable medium may include, but is not limited to, floppy diskettes, optical disks, CD-ROMs, and magneto-optical disks, ROMs, RAMs, EPROMs, EEPROMs, magnetic or optical cards, or other type of media/machine-readable medium suitable for storing electronic program code.

Throughout the foregoing description, for the purposes of explanation, numerous specific details were set forth in order to provide a thorough understanding of the invention. It will be apparent, however, to one skilled in the art that the invention may be practiced without some of these specific details. For example, it will be readily apparent to those of skill in the art that the functional modules and methods described herein may be implemented as software, hardware or any combination thereof. Moreover, although some embodiments of the invention are described herein within the context of a mobile computing environment, the underlying principles of the invention are not limited to a mobile computing implementation. Virtually any type of client or peer data processing devices may be used in some embodiments including, for example, desktop or workstation computers. Accordingly, the scope and spirit of the invention should be judged in terms of the claims which follow.

Embodiments of the invention may include various steps as set forth above. The steps may be embodied in machine-executable instructions which cause a general-purpose or special-purpose processor to perform certain steps. Alternatively, these steps may be performed by specific hardware components that contain hardwired logic for performing the steps, or by any combination of programmed computer components and custom hardware components.

We claim:

1. A method comprising:
performing authentication over a network with an authentication service to authenticate a client;
responsively generating a token at the authentication service, the token including identification information for the client, a service, and a type of authenticator used for the authentication, the token further including verification data;
transmitting the token to the client;
transmitting the token from the client to the service, the service using the verification data to verify the token and allowing or denying one or more transactions with the client based, at least in part, on the type of authenticator used for the authentication.

2. The method as in claim 1 wherein the verification data comprises a signature over the identity of the client, the service, and/or the type of authenticator used for the authentication.

3. The method as in claim 1 wherein the signature is generated with a first key and wherein the service verifies the signature using either the first key or a second key corresponding to the first key.

4. The method as in claim 1 wherein both the authentication service and the service are implemented within a network perimeter of a relying party.

5. The method as in claim 1 wherein the authentication service is implemented by an identity provider external to a relying party implementing the service.

6. The method as in claim 1 wherein performing authentication comprises implementing a biometric authenticator on the client to generate an authentication result; and
securely transmitting the result to the authentication service.

7. The method as in claim 1 wherein the service queries a policy database using the identification information for the authenticator to determine one or more characteristics of the authenticator and to allow or deny the one or more transactions based, at least in part, on the one or more characteristics of the authenticator.

8. The method as in claim 7 wherein at least one of the characteristics of the authenticator comprises a measure of reliability and accuracy of the authenticator.

9. The method as in claim 8 wherein at least one of the characteristics of the authenticator comprises a level of security with which the authenticator is implemented.

10. The method as in claim 7 wherein, in addition to the characteristics of the authenticator, the service allows or denies the transaction based on one or more characteristics of the transaction.

11. The method as in claim 8 wherein the characteristics of the transaction include an amount of money involved in the transaction.

12. A method comprising:
performing authentication over a network with an networking device having authentication capabilities to authenticate a client, the network authentication performed over a secure communication channel;
generating first identification information at the networking device identifying a type of authenticator used for the authentication;
receiving network packets transmitted from the client device to a service;
modifying the network packets to include the first identification information and routing the network packets to the service; and
the service using the first identification information to determine the type of authenticator used for the authentication and allowing or denying one or more transactions with the client based, at least in part, on the type of authenticator used for the authentication.

13. The method as in claim 12 further comprising:
the networking device identifying the first identification information by querying a data structure containing a mapping between authentication device ID codes and virtual identifier (VID) codes, the first identification information comprising one of the VID codes associated with an authentication device ID code for the authenticator used for the authentication.

14. The method as in claim 13 wherein the network device comprises a Firewall, a virtual private network (VPN) device, or a transport layer security (TLS) endpoint.

15. The method as in claim 12 wherein both the network device and the service are implemented within a network perimeter of a relying party offering the service.

16. The method as in claim 12 wherein performing authentication comprises implementing a biometric authenticator on the client to generate an authentication result; and
securely transmitting the result to the network device.

17. The method as in claim 12 wherein the service queries a policy database using the first identification information for the authenticator to determine one or more characteristics of the authenticator and to allow or deny the one or more transactions based, at least in part, on the one or more characteristics of the authenticator.

18. The method as in claim 17 wherein at least one of the characteristics of the authenticator comprises a measure of reliability and accuracy of the authenticator.

19. The method as in claim 18 wherein at least one of the characteristics of the authenticator comprises a level of security with which the authenticator is implemented.

20. The method as in claim 17 wherein, in addition to the characteristics of the authenticator, the service allows or denies the transaction based on one or more characteristics of the transaction.

21. The method as in claim 8 wherein the characteristics of the transaction include an amount of money involved in the transaction.
